(19) United States
(12) Patent Application Publication
(10) Pub. No.: US 2014/0168267 A1
(43) Pub. Date: Jun. 19, 2014

(54) AUGMENTED REALITY SYSTEM AND CONTROL METHOD THEREOF

(71) Applicant: Samsung Electronics Co., Ltd., Suwon-si (KR)

(72) Inventors: Hark-Joon KIM, Ansan-si (KR); Tack-Don HAN, Seoul (KR); Ha-Young KIM, Seoul (KR); Jong-Hoon SEO, Seoul (KR); Seung-Ho CHAE, Seoul (KR)

(73) Assignee: Samsung Electronics Co., Ltd., Suwon-si (KR)

(21) Appl. No.: 14/103,036

(22) Filed: Dec. 11, 2013

(30) Foreign Application Priority Data
Dec. 18, 2012 (KR) 10-2012-0148048

(51) Int. Cl. G06T 19/00; G06T 3/60; G06T 3/40; G06F 3/01

(52) U.S. Cl. CPC G06T 19/006; G06F 3/017; G06T 3/60; G06T 3/40
USPC 345/633

(57) ABSTRACT

A projection-based augmented reality system and a control method thereof are provided. The control method of an augmented reality system includes determining a conversion area to be converted from a work area based on a first gesture, acquiring a captured image of the determined conversion area, generating a virtual image of the determined conversion area from the acquired captured image, displaying the generated virtual image in the work area, and performing a manipulation function with respect to the displayed virtual image based on a second gesture.

### CROSS-REFERENCE TO RELATED APPLICATION(S)

This application claims the benefit under 35 U.S.C. §119(a) of a Korean patent application filed on Dec. 18, 2012 in the Korean Intellectual Property Office and assigned Serial No. 10-2012-0148048, the entire disclosure of which is hereby incorporated by reference.

### TECHNICAL FIELD

The present disclosure relates to an augmented reality system and a control method thereof. More particularly, the present disclosure relates to an augmented reality system using a projector and a camera and a control method thereof.

### BACKGROUND

In recent years, studies on augmented reality system have been continued. However, the augmented reality system of the related art does not consider a projection-based augmented reality situation using a projector. Given interaction with a user, there is an interaction technology using a touch on a display apparatus as a related technology. The interaction with a user is, however, limited to the touch on the display apparatus, and user's convenience is limited thereto. Further, the conventional augmented reality system does not take into various scenarios utilizing vision through a camera.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a projection-based augmented reality system and a control method thereof which uses various interactions taking into account a user's convenience.

In accordance with an aspect of the present disclosure, a method to control an augmented reality system is provided. The method includes determining a conversion area to be converted from a work area based on a first gesture, acquiring a captured image of the determined conversion area, generating a virtual image of the determined conversion area from the acquired captured image, displaying the generated virtual image in the work area, and performing a manipulation function with respect to the displayed virtual image based on a second gesture.

The method may further include displaying an area guide in the work area, and moving, zooming in, zooming out or rotating the displayed area guide based on the first gesture, wherein the determining of the conversion area may include determining a part of the work area corresponding to the area guide, as the conversion area.

The first gesture may include an operation for designating a boundary showing the conversion area from the work area, and the generating of the virtual image may include generating the virtual image of the part of the captured image corresponding to the designated boundary.

The manipulation function may include at least one of moving, changing, rotating and storing the virtual image.

The performing the manipulation function may include designating a moving path of the conversion area based on the second gesture, and moving the virtual image along the designated moving path.

The method may further include displaying a second virtual image in a location of at least one marker on the work area corresponding to the marker.

The method may further include moving and displaying the second virtual image according to the movement of the marker.

The method may further include performing the manipulation function with respect to the second virtual image based on the second gesture.

The displaying of the second virtual image may comprise displaying a plurality of menu items and displaying a virtual image with an effect corresponding to a menu item selected based on a third gesture.

In accordance with another aspect of the present disclosure, an augmented reality system is provided. The augmented reality system includes a camera to acquire a captured image of a work area, a projector to project an image to the work area, and a control device configured to determine a conversion area to be converted from the work area based on a first gesture, generate a virtual image of the determined conversion area based on a captured image acquired by the camera, display the generated virtual image in the work area using the projector, and perform a manipulation function with respect to the displayed virtual image based on a second gesture.

The control device may display an area guide in the work area using the projector, move, zoom in, zoom out or rotate the displayed area guide based on the first gesture, and determine a part of the work area corresponding to the area guide, as the conversion area.

The first gesture may include a gesture for designating a boundary showing the conversion area from the work area, and the control device may generate the virtual image of a part of the captured image corresponding to the designated boundary.

The manipulation function may include at least one of movement, change, rotation and storage of the virtual image.

The control device may designate a moving path of the conversion area based on the second gesture and moves the virtual image along the designated moving path.

The control device may display a second virtual image in a location of at least one marker on the work area corresponding to the marker using the projector.

The control device may move and display the second virtual image according to the movement of the marker.

The control device may perform the manipulation function with respect to the second virtual image based on the second gesture.

The second virtual image may include a plurality of menu items, and the control device may display a virtual image with an effect corresponding to a menu item selected based on a third gesture from the plurality of menu items.

In accordance with another aspect of the present disclosure, a method to control an augmented reality system is provided. The method includes displaying a first virtual image in one of a work area a part of a user's body located within the work area, changing the virtual image into a second virtual image and displaying the second virtual image based on a first gesture, and performing a manipulation function with respect to the displayed second virtual image based on a second gesture.

The displaying may include displaying the one of the first virtual image and the second virtual image in a size corresponding to the part of the body.

The method may further include selecting the second virtual image as a virtual image to which the manipulation function is performed based on a third gesture.

The method may further include displaying the selected second virtual image in a size corresponding to the work area.

The changing of the virtual image and displaying of the second virtual image may include displaying the second virtual image as a next image after the displaying of the first virtual image selected from a plurality of stored virtual images.

The manipulation function may include at least one of movement, change, rotation and storage of the virtual image.

In accordance with another aspect of the present disclosure, an augmented reality system is provided. The augmented reality system includes a camera to acquire a captured image of a work area, a projector to project an image to the work area, and a control device configured to display a first virtual image in one of the work area and a part of a user's body located within the work area using the projector, change the first virtual image into a second virtual image and display the second virtual image based on a first gesture using the acquired captured image, and perform a manipulation function with respect to the displayed second virtual image based on a second gesture.

The control device may display one of the first virtual image and the second virtual image in a size corresponding to the part of the user's body.

The control device may select the second virtual image as a virtual image to which the manipulation function is performed based on a third gesture.

The control device may display the selected second virtual image in a size corresponding to the work area.

The control device may display the second virtual image as a next image after displaying the first virtual image selected from a plurality of stored virtual images.

The manipulation function may include at least one of movement, change, rotation and storage of the virtual image.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an augmented reality system according to an embodiment of the present disclosure;

FIG. 2 illustrates an example of the environment in which a work is performed by using the augmented reality system according to an embodiment of the present disclosure;

FIGS. 3A, 3B, 3C and 3D illustrate implementation examples of cameras and projectors according to an embodiment of the present disclosure;

FIG. 4 is a flowchart showing operations of the augmented reality system according to an embodiment of the present disclosure;

FIGS. 5A1, 5B1, 5C1, 5D1, 5A2, 5B2, 5C2, 5D2, and 5E illustrate examples of a user's interaction and corresponding operations of an augmented reality system according to an embodiment of the present disclosure;

FIG. 6 illustrates another example of zooming in a virtual image corresponding to a user's gesture according to an embodiment of the present disclosure;

FIGS. 7A and 7B illustrate examples of designating a conversion area and of implementing a manipulation function with respect to a virtual image by a user's gesture according to an embodiment of the present disclosure;

FIG. 8 illustrates another example of designating a conversion area and of implementing a manipulation function with respect to a virtual image by a user's gesture according to an embodiment of the present disclosure;

FIGS. 9A and 9B illustrate another example of designating a conversion area and of implementing a manipulation function with respect to a virtual image by a user's gesture according to an embodiment of the present disclosure;

FIG. 10 illustrates another example of implementing a manipulation function with respect to a virtual image by a user's gesture according to an embodiment of the present disclosure;

FIGS. 11A, 11B, and 11C illustrate examples of applying a virtual effect by a user's gesture according to an embodiment of the present disclosure;

FIG. 12 illustrates another example of implementing a manipulation function with respect to a virtual image by a user's gesture according to an embodiment of the present disclosure;

FIGS. 13A and 13B illustrate examples of applying an animation effect by a user's gesture according to an embodiment of the present disclosure;

FIG. 14 is a flowchart illustrating another example of operations of the augmented reality system according to an embodiment of the present disclosure;

FIGS. 15A1, 15B1, 15C1, 15A2, 15B2, 15C2, and 15D illustrate examples of implementing a manipulation function with respect to a virtual image by a user's gesture according to an embodiment of the present disclosure;

FIG. 16 illustrates another example of changing a virtual image by a user's gesture according to an embodiment of the present disclosure;

FIGS. 17A, 17B, and 17C illustrate another example of changing a virtual image and of implementing a manipulation function by a user's gesture according to an embodiment of the present disclosure;

FIG. 18 illustrates another example of displaying a virtual image by a user's gesture according to an embodiment of the present disclosure;

FIGS. 19A, 19B, and 19C illustrate examples of displaying a virtual image by a user's gesture according to an embodiment of the present disclosure;

FIG. 20 illustrates an example of displaying a virtual image by using a marker according to an embodiment of the present disclosure;

FIGS. 21A, 21B, and 21C illustrate examples of displaying a virtual image by using the marker according to an embodiment of the present disclosure;

FIG. 22 illustrates another example of displaying a virtual image by using the marker according to an embodiment of the present disclosure; and

FIGS. 23A, 23B, and 23C illustrate examples of displaying a virtual image by using the marker according to an embodiment of the present disclosure.

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

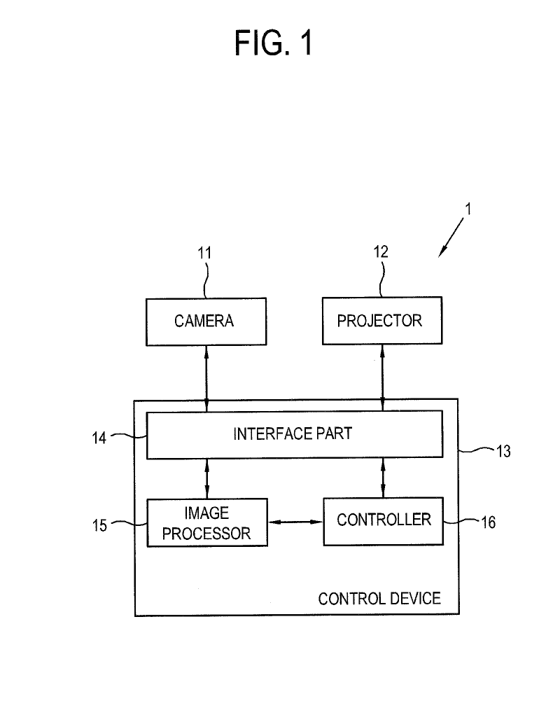

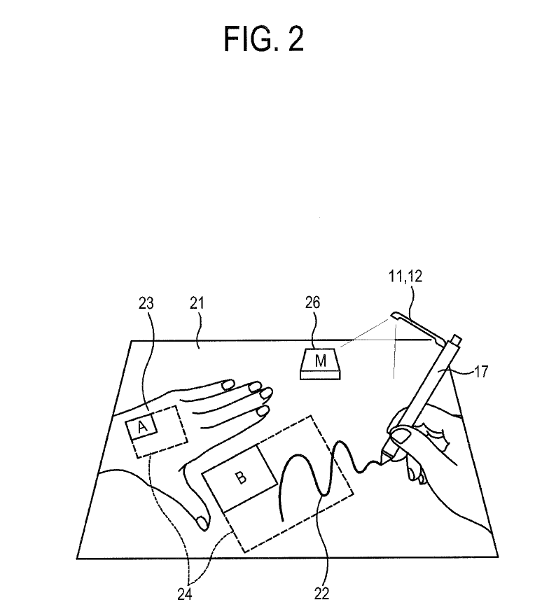

FIG. 1 is a block diagram of an augmented reality system according to an embodiment of the present disclosure and FIG. 2 illustrates an example of the environment in which a work is performed by using an augmented reality system according to an embodiment of the present disclosure.

Referring to FIGS. 1 and 2, the augmented reality system 1 may include a camera 11, a projector 12, and a control device 16. The camera 11 is used to implement a vision in the augmented reality by capturing an image of an area in which a work is performed as illustrated by the work area 21 in FIG. 2. The camera 11 may recognize a user's gesture. The camera 11 may be implemented as a single camera, or include an infrared first camera for recognizing a user's gesture and a second camera for recognizing an image of the work area. The projector 12 projects and displays a virtual image 24 in the work area 21. The control device 13 is connected to the camera 11 and the projector 12, processes images related to the augmented reality, and performs overall control operations.

The control device 13 may be connected to the camera 11 and the projector 12 in a wired or wireless manner. The control device 13 may be implemented as a separate device from at least one of the camera 11 and the projector 12, or implemented as a single device incorporating the camera 11 and the projector 12. The control device 13 generates a virtual image 24 by a gesture made by a part of a user's body, e.g., by a user's hand 23 based on a captured image acquired through the camera 11, and displays the generated virtual image 24 in the work area 21 through the projector 12. Referring to FIG. 1, the control device 13 may include an interface part 14, an image processor 15 and a controller 16. The interface part 14 communicates with the camera 11 and the projector 12. The image processor 15 processes the captured image acquired through the camera 11 and generates the virtual image 24 therefrom according to a control of the controller 16. The controller 16 controls the image processor 15 to generate the virtual image 24 by a user's gesture and to display the generated virtual image 24 in the work area 21. The controller 16 may include a control program to perform the foregoing control operations, a non-volatile memory such as a flash memory or a hard disc drive to store the control program therein, a volatile memory such as a Random Access Memory (RAM) for loading all or part of the stored control program, and a microprocessor such as a Central Processing Unit (CPU) to execute the loaded control program. The image processor 15 may be also provided in the form of software module, in which chase, it may share hardware (non-volatile memory, volatile memory and microprocessor) of the controller 16.

Referring to FIG. 2, the work area 21 as a physical work space refers to a planar surface such as a desk, a floor, a wall, a blackboard, or paper. A user may draw a picture or write 22 (hereinafter, collectively the “picture, etc.”) in the work area 21 by using a writing instrument such as a pen 17. According to an embodiment of the present disclosure, the camera 11 and the projector 12 may be provided in the pen 17.

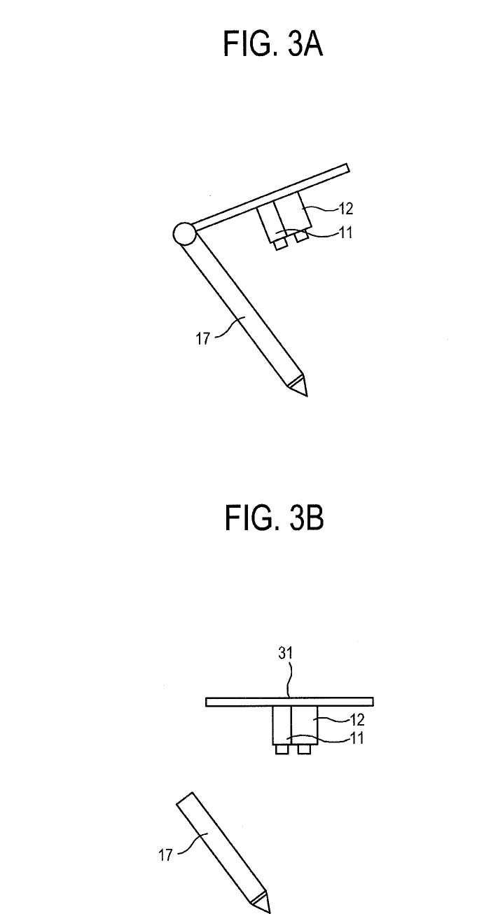

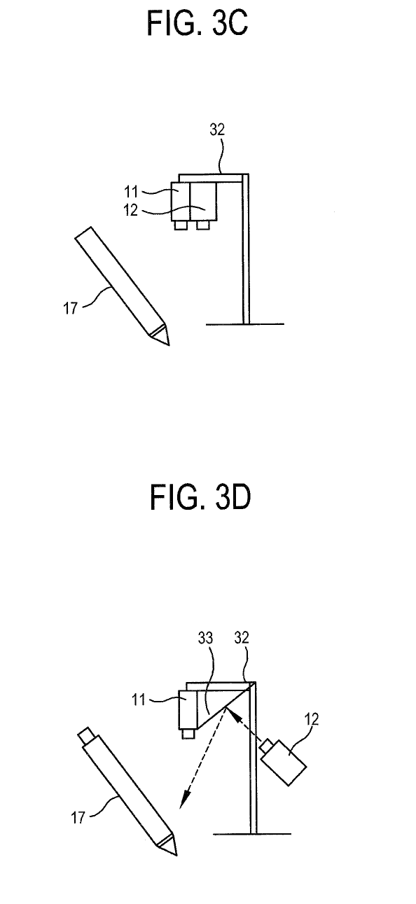

FIGS. 3A. 3B, 3C and 3D illustrate implementation examples of the camera 11 and the projector 12 according to an embodiment of the present disclosure.

Referring to FIG. 3A, the camera 11 and the projector 12 may be attached to the pen 17, or as shown in FIG. 3B, may be installed in a ceiling or a wall 31 separately from the pen 17. According to another embodiment of the present disclosure, the camera 11 and the projector 12 may be installed in a support 32 as shown in FIG. 3C. According to another embodiment of the present disclosure, as shown in FIG. 3D, the projector 12 may be separately provided from the camera 11, and may project a virtual image through a reflecting means 33 provided in the support 32. According to another embodiment of the present disclosure, both the camera 11 and the projector 12 may capture and project images through the reflecting means 33 (not shown). For convenience, the control device 13 will not be shown in FIGS. 2 and 3 and subsequent drawings.

Referring back to FIG. 2, a user makes a gesture 23 for interaction of the augmented reality in the work area 21. The user's gesture 23 may vary, and e.g., may be made by the other hand which does not grip the pen 17. The user's gesture 23 may include a particular shape of a hand or a motion. The camera 11 acquires a captured image including the gesture 23. The acquired captured image is transmitted to the control device 13. The control device 13 generates a virtual image 24 corresponding to the user's gesture 23. The generated virtual image 24 is displayed in the work area 21 through the projector 12. The virtual image 24 includes not only a still image but also a moving image. The virtual image 24 may be displayed in a part of a user's body 23 such as a user's hand, or displayed in a certain location in the work area 21 which is outside of the part of the user's body 23. The virtual image 24 may be displayed in a location corresponding to a picture 22, which is being drawn by a user through the pen 17, or displayed in another location in the work area 21 irrespective of the picture 22. A user may perform interaction by using a marker 26 as a real object that a user may touch by his/her hand (to be described in more detail later).

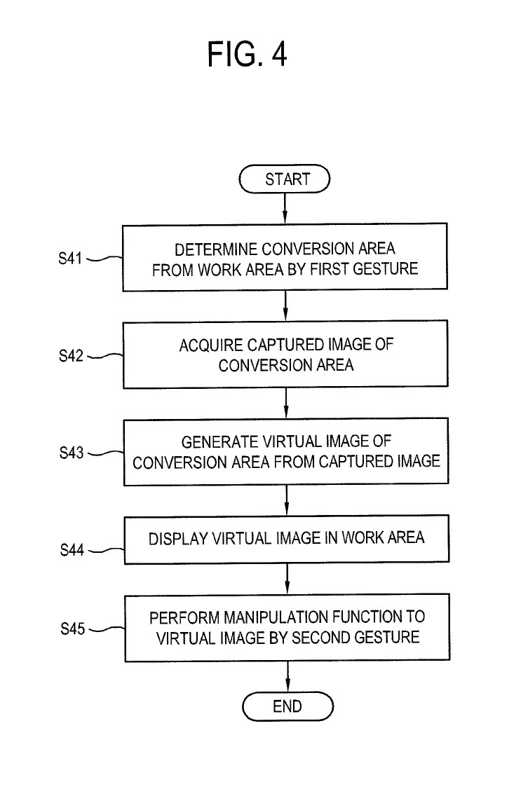

FIG. 4 is a flowchart showing operations of the augmented reality system 1 according to an embodiment of the present disclosure.

Referring to FIG. 4, the augmented reality system 1 determines a conversion area to be converted from the work area 21 by a user's first gesture at operation S41. The augmented reality system 1 acquires a captured image of the determined conversion area, by using the camera 11 at operation S42. The augmented reality system 1 generates the virtual image 24 of the conversion area from the acquired captured image, by using the control device 13 at operation S43. The augmented reality system 1 displays the generated virtual image 24 in the work area 21 by using the projector 12 at operation S44. The augmented reality system 1 performs a manipulation function with respect to the displayed virtual image 24 by a user's second gesture at operation S45. Hereinafter, the augmented reality system 1 according to an embodiment of the present disclosure will be described in more detail.

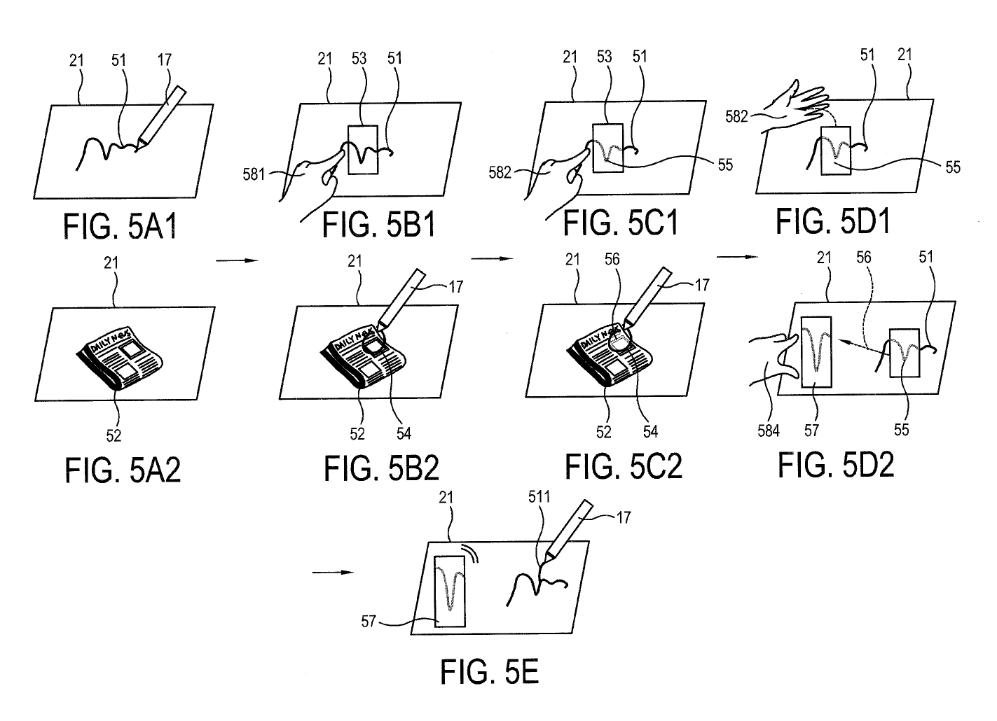

FIGS. 5A1, 5B1, 5C1, 5D1, 5A2, 5B2, 5C2, 5D2, and 5E illustrate examples of a user's interactions and corresponding operations of the augmented reality system according to an embodiment of the present disclosure.

Referring to FIG. 5A1, a user draws a picture 51 in the work area 21 by using the pen 17. According to another embodiment of the present disclosure, referring to FIG. 5A2, a picture 52 may be provided in the work area 21. Referring to FIG. 5B1, a user makes a predetermined gesture 581 and designates a conversion area 53 to be converted. The user's gesture 581 for designating the conversion area 53 may vary, including, e.g., a hand gesture for shaping a box corresponding to the conversion area 53 on the picture, etc. 51. In an embodiment of the present disclosure, a predetermined image (which will be described in detail later) may be displayed to guide the designation of the conversion area 53. According to another embodiment of the present disclosure, referring to FIG. 5B2, a user may draw a boundary 54 showing the conversion area on the picture 52 by using the pen 17 as a gesture for designating the conversion area 53. If the conversion area 53 or the boundary 54 is designated or determined, the control device 13 analyzes a captured image including the conversion area 53 or the conversion area 53 within the boundary 54, and generates a virtual image corresponding to the conversion area 53 or the conversion area within the boundary 54.

Referring to FIG. 5C1, the augmented reality system 1 projects a generated virtual image 55 to the conversion area 53 and displays the virtual image 55. According to another embodiment of the present disclosure, referring to in FIG. 5C2, the augmented reality system 1 projects a generated virtual image 56 to the conversion area 53 within the boundary 54 and displays the virtual image 56. Referring to FIG. 5D1, a user makes a gesture 583 for performing a predetermined manipulation function with respect to the displayed virtual image 55. For example, a user may make the gesture 583 touching the virtual image 55 with his/her hand and then removing his/her hand from the virtual image 55, to thereby perform the manipulation function to store the virtual image 55 in the augmented reality system 1. As another example, referring to FIG. 5D2, a user drags the virtual image 55 in a direction 56 while in contact with the virtual image 55 with his/her finger so that the augmented reality system 1 may perform a manipulation function to move the virtual images 55 and 57. As another example, a user pinches in the virtual image 57 while in contact with the virtual image 57 with two fingers so that the augmented reality system 1 may perform a manipulation function to zoom in the virtual image 57. Referring to FIG. 5E, the augmented reality system 1 performs a manipulation function with respect to the virtual image 57 corresponding to a user's various gestures. Thus, a user may draw a desired picture, etc. 511 by using the pen 17 while manipulating the virtual image 57. That is, according to the manipulation corresponding to a user's various gestures, the virtual image 57 is changed through movement, deformation, or rotation.

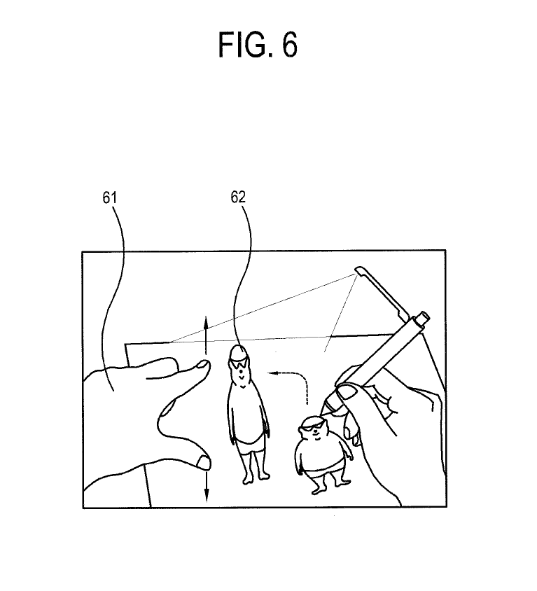

FIG. 6 illustrates another example of zooming in a virtual image 62 corresponding to a user's gesture 61 according to an embodiment of the present disclosure.

Referring to FIG. 6, a manipulation function with respect to the virtual image 62 is not limited thereto, and may vary including zooming out or rotating the virtual image 62 or changing a color or texture of the virtual image 62. According to an embodiment of the present disclosure, the changed virtual image 62 may be compared to or referred to with the actual picture to enhance the user's convenience.

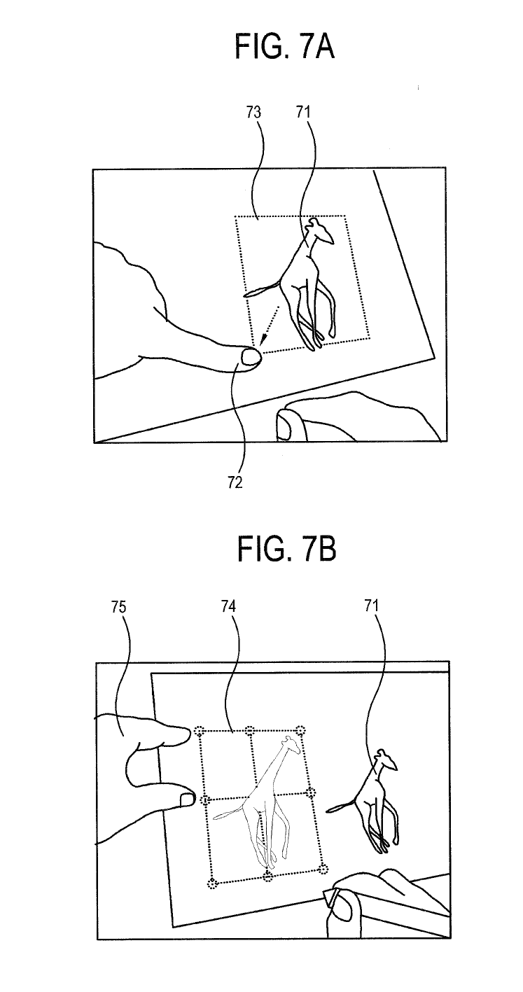

FIGS. 7A and 7B illustrate examples of designating a conversion area and of implementing a manipulating function with respect to a virtual image by a user's gesture according to an embodiment of the present disclosure.

Referring to FIG. 7A, the augmented reality system 1 displays a guide image 73 on a picture 71 to guide the designation of a conversion area. The guide image 73 according to an embodiment of the present disclosure may be in the form of a box. The augmented reality system 1 may further display a cursor (not shown) to show a central point of the guide image 73. A user may move the central point of the guide image 73 by making a gesture 72 by touching and dragging the cursor. If the central point of the guide image 73 is determined in a predetermined location, the guide image 73 may gradually become larger by the user's gesture 72. If the guide image 73 reaches a desired size, a user suspends the gesture 72 and the augmented reality system 1 determines a corresponding area of the current guide image 73, as a conversion area.

Referring to FIG. 7B, the augmented reality system 1 generates a virtual image 74 corresponding to the conversion area determined by the guide image 73, and displays the generated virtual image 74. A user makes an additional gesture 75, e.g., pinches in or out the virtual image 74 while in contact with the virtual image 74, to thereby zoom in or zoom out the virtual image 74. The augmented reality system 1 analyzes a captured image, identifies the user's gesture 75, changes the size of the virtual image 74, and displays the changed virtual image 74 as a corresponding manipulation function.

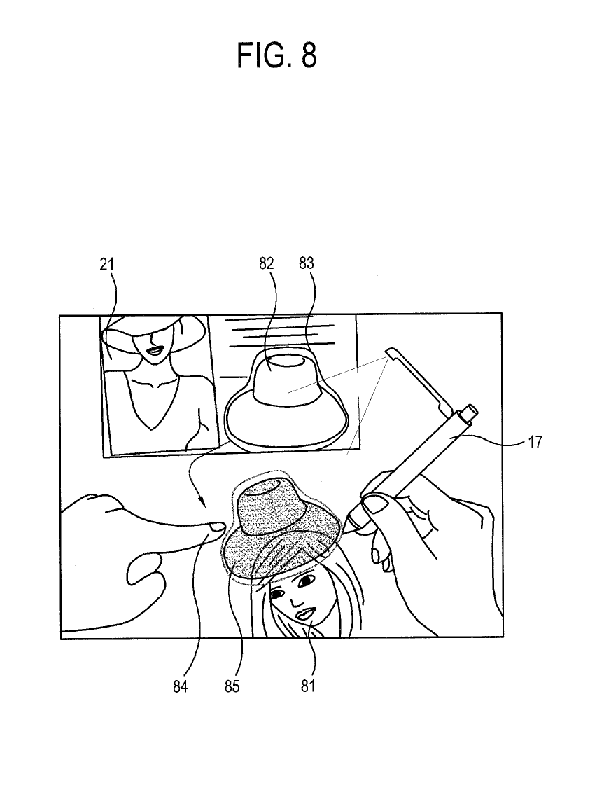

FIG. 8 illustrates another example of designating a conversion area and of implementing a manipulation function with respect to a virtual image by a user's gesture according to an embodiment of the present disclosure.

Referring to FIG. 8, a user draws a boundary 83 for designating a conversion area using the pen 17 with respect to the picture 82 included in photo, magazine, newspaper, etc. provided in the work area 21. According to another embodiment of the present disclosure, the picture 82 may be drawn in advance by a user. If a user makes a gesture to determine a conversion area, e.g., touches the conversion area provided within the boundary 83, a virtual image 85 is displayed corresponding to the conversion area provided within the boundary 83. If a user makes a gesture 84 dragging the virtual image 85 while in contact with the virtual image 85, the virtual image 85 is moved toward a picture 81 that is being drawn by a user. According to another embodiment of the present disclosure, the picture 81 may be a picture that is currently drawn by a user as well as a picture that is drawn in advance by a user. According to an embodiment of the present disclosure, portions of several pictures may be gathered to be used as the picture 81.

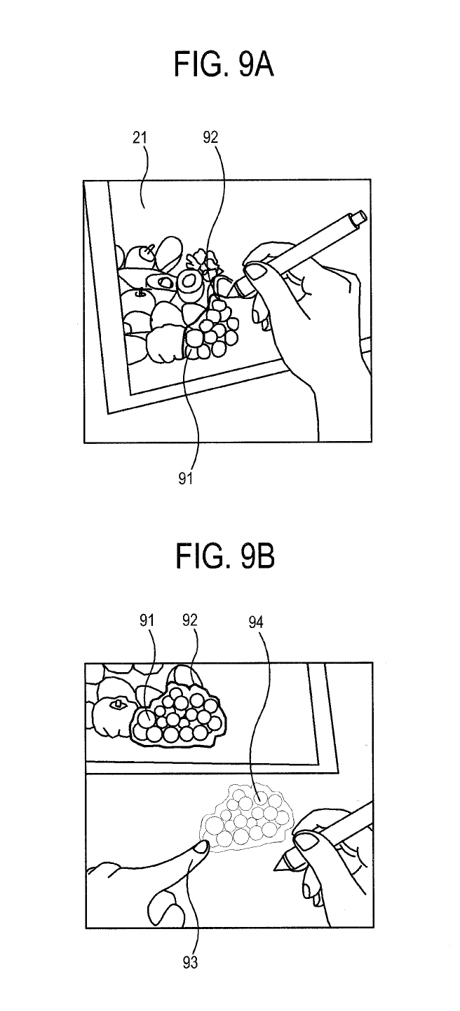

FIGS. 9A and 9B illustrate another example of designating a conversion area and of implementing a manipulation function with respect to a virtual image by a user's gesture according to an embodiment of the present disclosure.

Referring to FIG. 9A, a user draws a boundary 92 for designating a conversion area in a picture 91 provided in the work area 21. Referring to FIG. 9B, if the boundary 92 for designating the conversion area with respect to the picture 91 is drawn, the augmented reality system 1 analyzes a captured image, identifies the boundary 92 and generates a virtual image of the conversion area provided within the boundary 92. The augmented reality system 1 displays the generated virtual image in a location corresponding to the boundary 92. If there is a user's gesture 93, the augmented reality system 1 performs a manipulation function with respect to the virtual image corresponding to the user's gesture 93. In the case of FIG. 9B, if a user gesture 93 by dragging the virtual image 94 downward while in contact with the virtual image 94, the virtual image 94 is moved to the dragging direction and displayed.

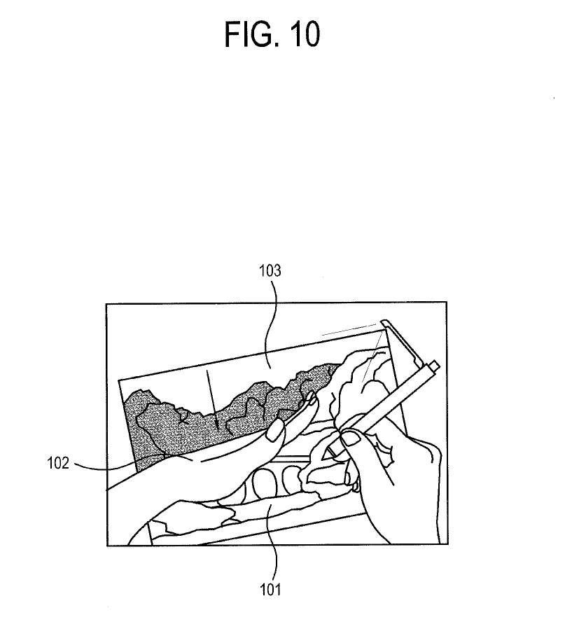

FIG. 10 illustrates another example of implementing a manipulation function with respect to a virtual image by a user's gesture according to an embodiment of the present disclosure.

Referring to FIG. 10, a predetermined virtual effect 103 may be applied to a picture 101 by a user's gesture 102.

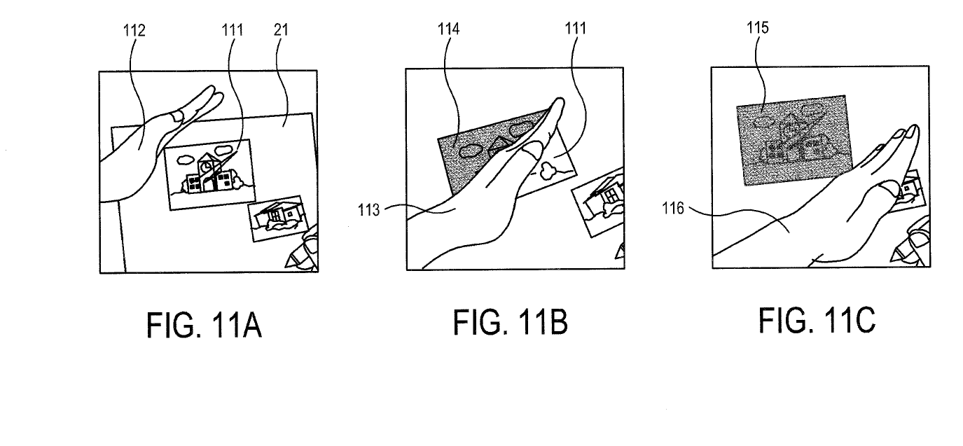

FIGS. 11A, 11B, and 11C illustrate examples of applying a virtual effect by a user's gesture according to an embodiment of the present disclosure.

Referring to FIG. 11A, a picture 111 is drawn in the work area 21. A user is in a preparation state 112 immediately before making a gesture to apply a virtual effect to the picture 111. For example, the preparation state 112 for a user's gesture may include a user's stretched hand standing in a location that is outside of the area of the picture 111. Referring to FIG. 11B, a user makes a gesture 113 over the picture 111 by displacing the user's hand with respect to the picture 111. The augmented reality system 1 applies a predetermined virtual effect to the part of the picture 111 that the hand has been displaced over, as a manipulation function corresponding to the gesture 113. A virtual effect 114 may include coloring the picture 111 in a predetermined color or applying a predetermined texture thereto. Referring to FIG. 11C, a user's gesture 116 refers to the state where the user's hand has passed over the picture 115 and the augmented reality system 1 applies a predetermined color or texture to the entire picture 115.

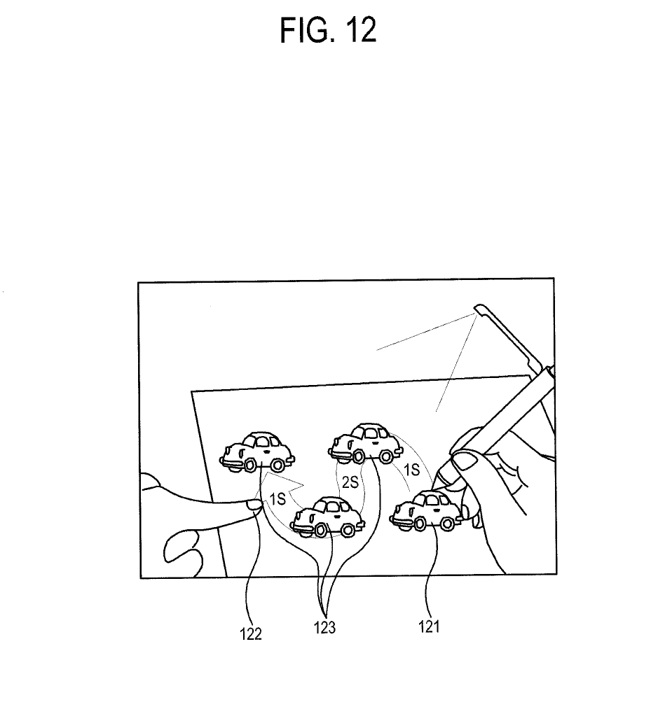

FIG. 12 illustrates another example of implementing a manipulation function with respect to a virtual image by a user's gesture according to an embodiment of the present disclosure.

Referring to FIG. 12, an animation effect 123 may apply to a picture 121 by a user's gesture 122.

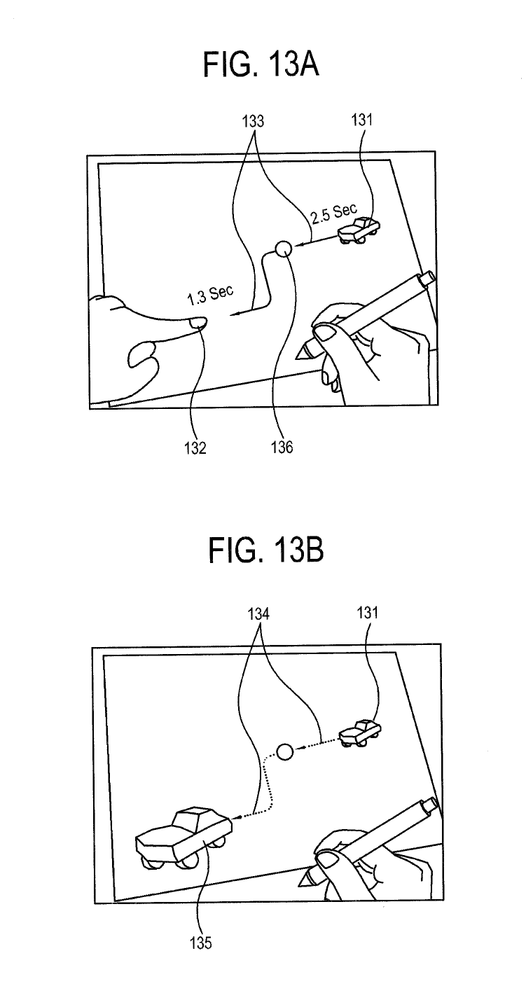

FIGS. 13A and 13B illustrate examples of applying an animation effect by a user's gesture according to an embodiment of the present disclosure.

Referring to FIG. 13A, a user may make a gesture 132 designating a moving path 133 according to the animation effect applied to the picture 131. More specifically, a user drags the picture 131 to the desired moving path 133 while in contact with the picture 131. The augmented reality system 1 displays the moving path 133 as a virtual image according to the user's gesture 132. If a user stops dragging the picture 131 at a predetermined point 136 for predetermined time, the augmented reality system 1 displays the animation time (e.g. 2.5 seconds) as a virtual image on the moving path 133. A user continues to make the gesture 132 designating the moving path 133, and the augmented reality system 1 displays the moving path 133 as a virtual image by the gesture 132.

Referring to FIG. 13B, if the designation of the moving path 134 is completed, the augmented reality system 1 generates a virtual image 135 corresponding to the picture 131, gradually moves the virtual image 135 from the picture 131 along the moving path 134 and displays the virtual image 135 to thereby provide the animation effect. The speed of moving the virtual image 135 is based on the time designated by a user.

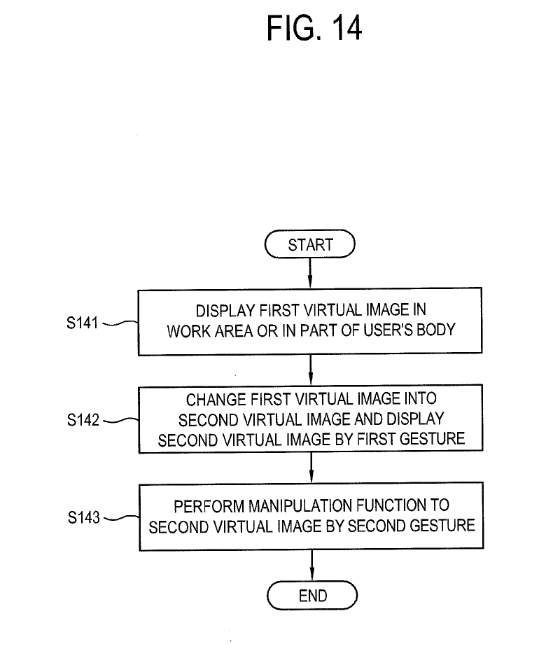

FIG. 14 is a flowchart illustrating another example of operations of the augmented reality system 1 according to an embodiment of the present disclosure.

The augmented reality system 1 displays a first virtual image in the work area or in a part of a user's body at operation S141. The augmented reality system 1 changes the first virtual image into a second virtual image and displays the second virtual image by a user's first gesture at operation S 142. The augmented reality system 1 performs a manipulation function with respect to the second virtual image by a user's second gesture at operation S143. Hereinafter, the present disclosure will be described in more detail.

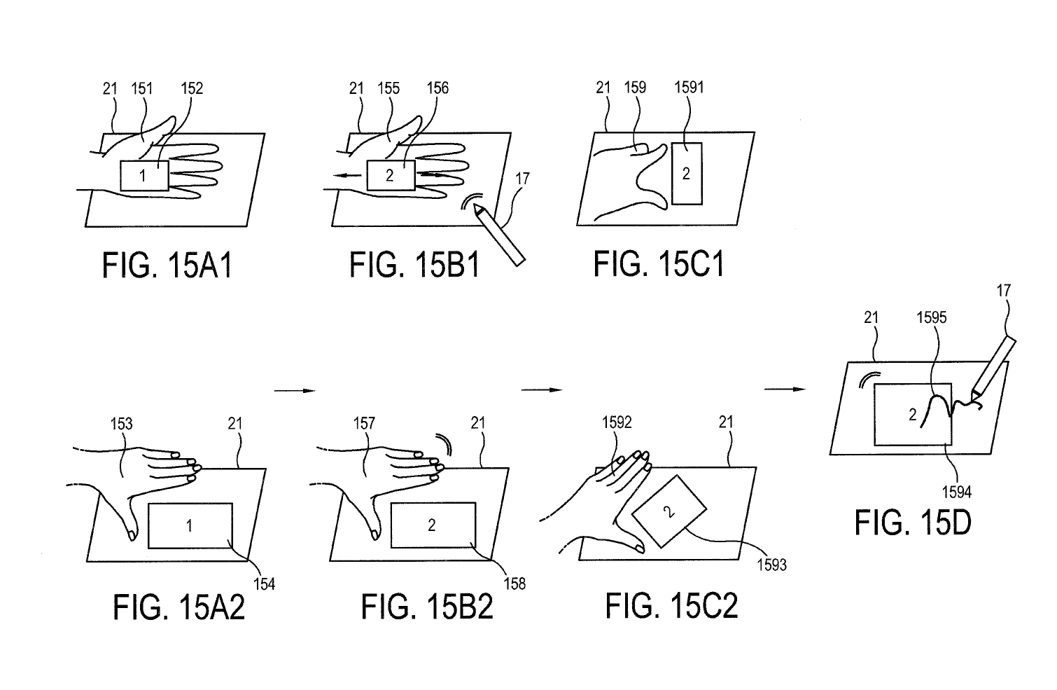

FIGS. 15A1, 15B1, 15C1, 15A2, 15B2, 15C2, and 15D illustrate examples of implementing a manipulation function with respect to a virtual image by a user's gesture according to an embodiment of the present disclosure.

Referring to FIG. 15A1, the augmented reality system 1 displays a first virtual image 152 in a part of a user's body, e.g. in a user's palm 151. In this case, the augmented reality system 1 analyzes a captured image and identifies a location and area of the user's palm 151 to display the first virtual image 152 in corresponding location and size. Referring to FIG. 15A2, the augmented reality system 1 may display the first virtual image 154 in the work area 21. In this case, the augmented reality system 1 may display the first virtual image 154 in location and size corresponding to the location or shape of the user's hand 153.

Referring to FIG. 15B1, a user makes a gesture 155 using his/her hand, and changes the first virtual image 152 into a second virtual image 156. Otherwise, the user's gesture may be made by using the pen 17. Referring to FIG. 15B2, another example illustrates that the user's gesture 157 is made to change the first virtual image 154 into a second virtual image 158. Referring to FIG. 15C1, a user makes an additional gesture 159 using his/her hand, and performs a manipulation function with respect to a second virtual image 1591. Referring to FIG. 15C2, another example illustrates that a user's gesture 1592 is used to perform a manipulation function with respect to a second virtual image 1593. The manipulation function may be the same as the manipulation function explained above with reference to FIGS. 1 to 14. Referring to FIG. 15D, a user may continue to draw a picture, etc. 1595 by using the pen 17, while manipulating the second virtual image 1594.

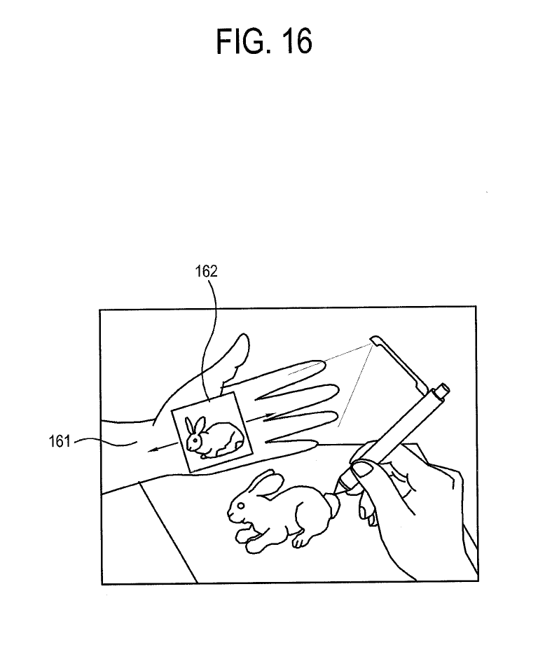

FIG. 16 illustrates another example of changing a virtual image by a user's gesture according to an embodiment of the present disclosure.

As described above, a user may use his/her palm as a user's gesture 161 as an auxiliary display for displaying a virtual image 162 thereon.

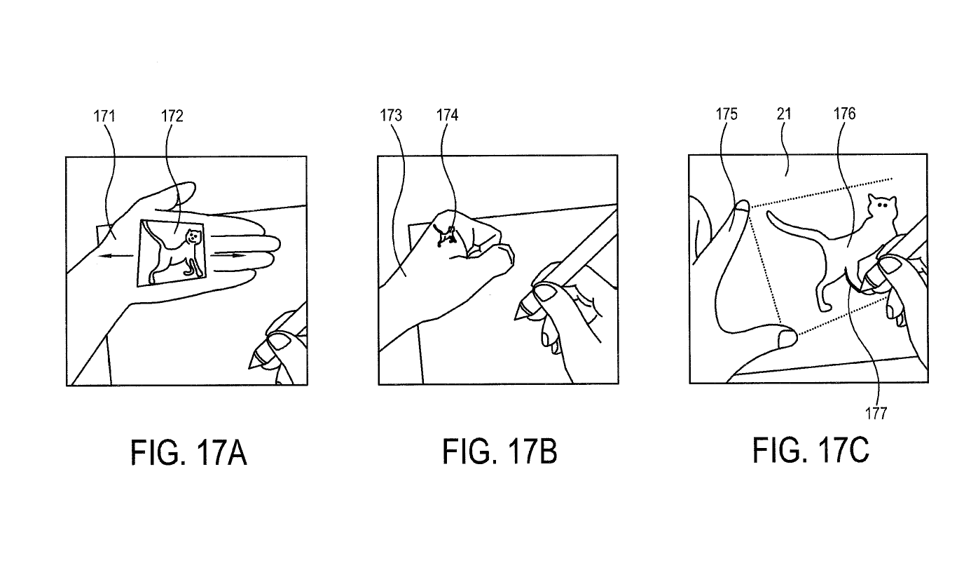

FIGS. 17A, 17B, and 17C illustrate another example of changing a virtual image and of performing a manipulation function by a user's gesture according to an embodiment of the present disclosure.

Referring to FIG. 17A, if a user makes a gesture 171 spreading his/her palm, the augmented reality system 1 displays a virtual image 172 on the user's palm. The virtual image 172 may be one of a plurality of virtual images stored in the augmented reality system 1. The plurality of virtual images stored in the augmented reality system 1 may be those stored by the manipulation function for storing the images, as explained with reference to FIG. 5D1. If a user makes a gesture by extending the user's fingers, the augmented reality system 1 may display a virtual image immediately following the currently displayed virtual image out of the plurality of stored virtual images. Accordingly, the virtual image 172 may be changed by the user's gesture 171. A user may search the desired virtual image 172 by his/her gesture 171.

Referring to FIG. 17B, if the desired virtual image 172 is found, a user makes another gesture 173, e.g., by closing the hand to form a fist, and accordingly, the augmented reality system 1 may display a reduced virtual image 174 on the fist of a user. According to another embodiment of the present disclosure, the virtual image 174 may be displayed in another place other than the user's fist. Referring to FIG. 17C, if a user makes a new gesture 175, e.g., extends two fingers and touches the work area 21 with the extended fingers, the augmented reality system 1 displays a virtual image 176 in a size suitable for work to be performed on the work area 21. Accordingly, a user may continue to draw a picture 177 by using the virtual image 176. For example, a user may zoom out or zoom in the virtual image 176 by the gesture using the extended fingers, or may move or rotate the virtual image 176 by another gesture.

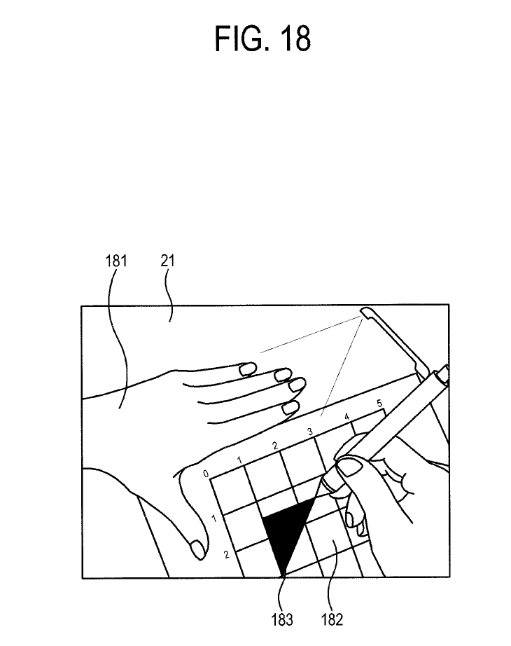

FIG. 18 illustrates another example of displaying a virtual image by a user's gesture according to an embodiment of the present disclosure.

Referring to FIG. 18, in this embodiment of the present disclosure, a user may make a gesture 181 by forming a right angle between two fingers, rotating the hand, and placing the hand on the work area 21 to thereby display a corresponding virtual image 182 and draw a picture 183 by using the virtual image 182.

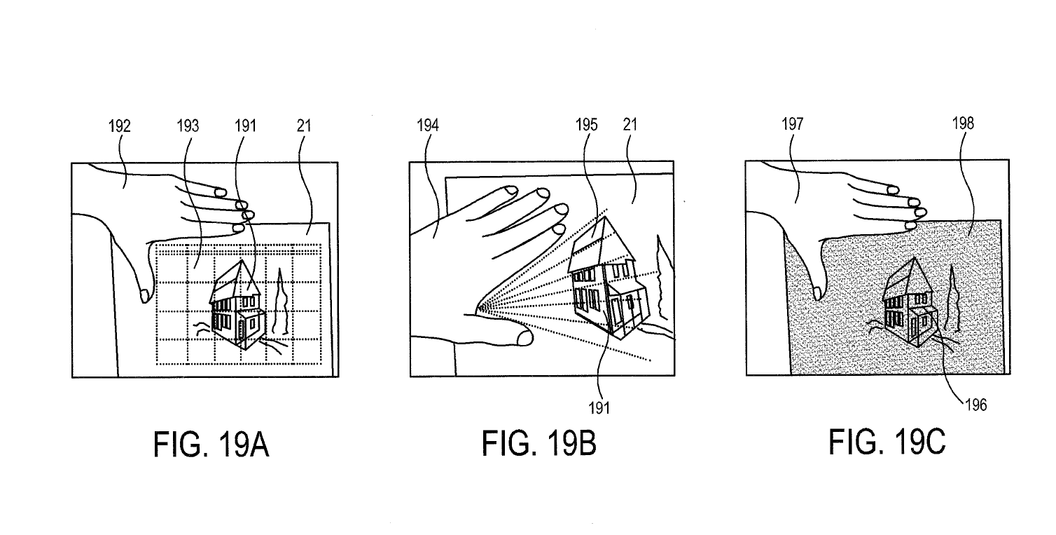

FIGS. 19A, 19B, and 19C illustrate examples of displaying a virtual image by a user's gesture according to an embodiment of the present disclosure.

Referring to FIG. 19A, an embodiment of the present disclosure illustrates an example of displaying a virtual image 193 in a grid on a picture 191 for guiding the drawing work, corresponding to a gesture 192 of putting a user's hand on the work area 21 at a right angle. Referring to FIG. 19B, an embodiment of the present disclosure illustrates displaying a virtual image 195 with the angle for a user to assume a vanishing point of the picture 191, corresponding to a gesture 194 of putting a user's hand on the work area 21 with the thumb and an index finger stretched out. Referring to FIG. 19C, an embodiment of the present disclosure illustrates displaying a virtual image 198 with the effect of applying a predetermined color, texture, or background image to a picture 196, corresponding to a gesture 197 of lifting a user's hand from the work area 21 and then putting the hand on the work area 21 again.

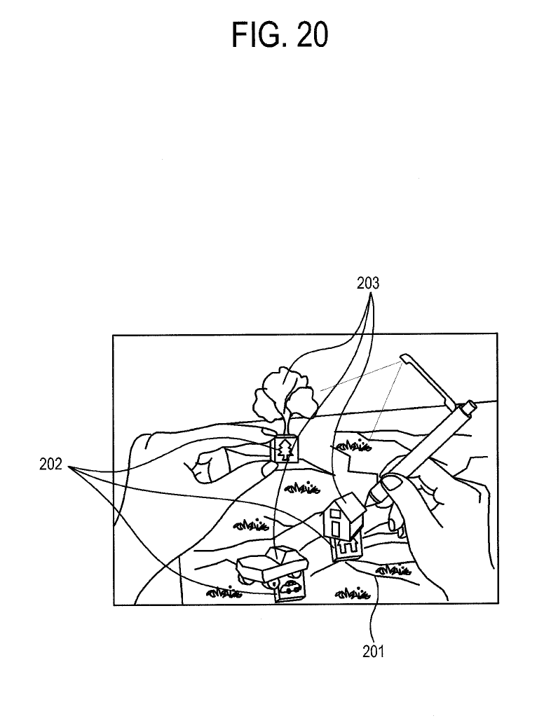

FIG. 20 illustrates an example of displaying a virtual image by using a marker according to an embodiment of the present disclosure.

Referring to FIG. 20, a marker 202 having a predetermined shape may be put on the work area 21 and may be touched or moved by a user. The augmented reality system 1 may recognize the marker 202 and display a virtual image 203 related to the content of a picture 201 corresponding to the marker 202. Accordingly, a user may move the marker 202 and change the composition or arrangement of the picture.

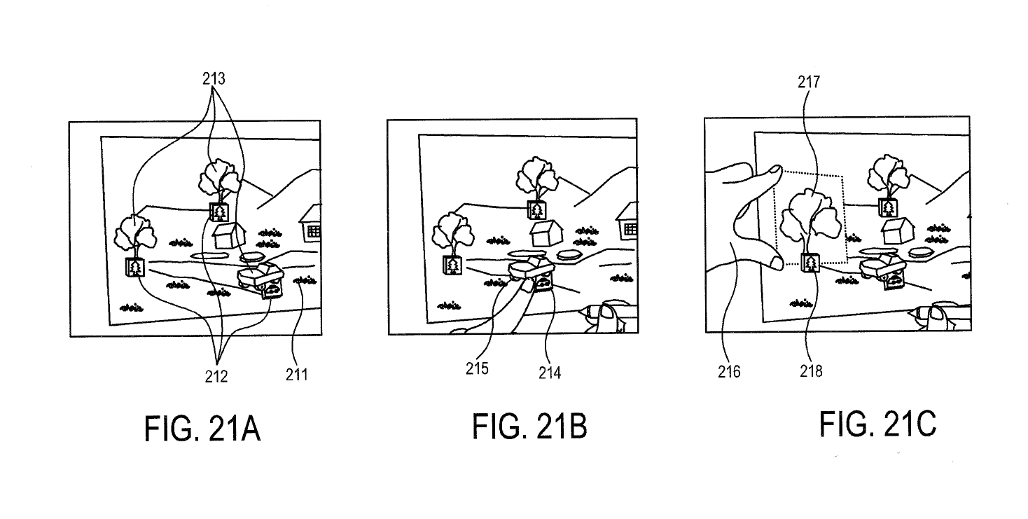

FIGS. 21A, 21B, and 21C illustrate examples of displaying a virtual image by using the marker according to an embodiment of the present disclosure.

Referring to FIG. 21A, an embodiment of the present disclosure illustrates an example of displaying a virtual image 213 corresponding to a location of the marker 212 on a picture 211. The virtual image 213 may show trees, cars, etc. corresponding to the shape of the trees and cars in the marker 212. Referring to FIG. 21B, a user may pick up and move a marker 214, and the augmented reality system 1 recognizes the movement of the marker 214, moves a corresponding virtual image 215 according to the movement of the marker 214, and displays the virtual image 215. Referring to FIG. 21C, a user may make a gesture 216 to perform a manipulation function with respect to a virtual image 217 displayed in a marker 218, e.g., may zoom in or zoom out the virtual image 217.

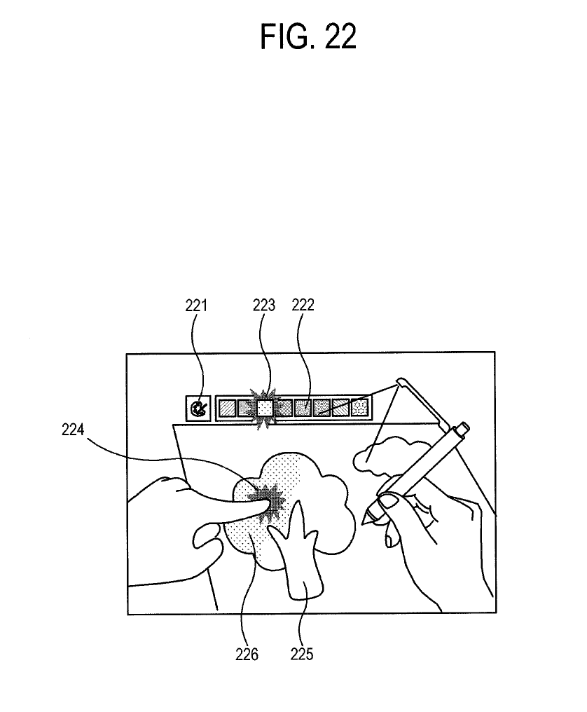

FIG. 22 illustrates another example of displaying a virtual image by using a marker according to an embodiment of the present disclosure.

Referring to FIG. 22, a virtual image 222 is displayed corresponding to a marker 221 and includes a plurality of menu items. A user may select one menu item 223 from the plurality of menu items and make a gesture 224 to apply the selected menu item 223 to a picture 225, and the augmented reality system 1 may display a virtual image 226 with the effect corresponding to the selected menu item 223.

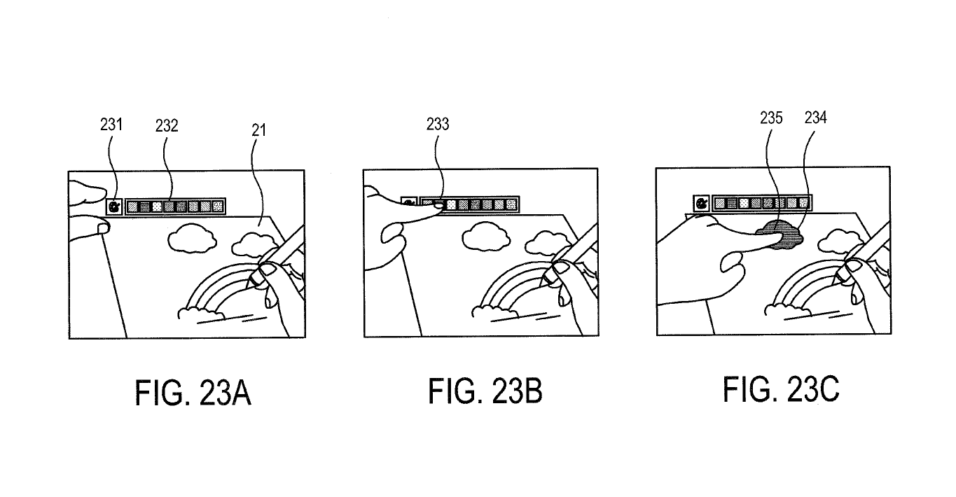

FIGS. 23A, 23B, and 23C illustrate detailed examples of displaying a virtual image by using the marker according to an embodiment of the present disclosure.

Referring to FIG. 23A, an embodiment of the present disclosure illustrates a marker 231 that is provided in a predetermined location on the work area 21. The augmented reality system 1 recognizes the marker 231 and displays a virtual image 232 including a plurality of menu items. The menu items according to the present embodiment may include a color palette. Referring to FIG. 23B, a user selects one menu item 233 out of a plurality of menu items of a virtual image 232. As shown in FIG. 23C, if a user selects a predetermined part 234 of a picture, the augmented reality system 1 displays a virtual image 235 with the effect of applying the color of the selected menu item 233 to the predetermined part 234 of the picture.

As described above, a projection-based augmented reality system and a control method thereof according to an embodiment of the present disclosure uses various interactions by taking into account a user's convenience.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method of controlling an augmented reality system, the method comprising:
determining a conversion area to be converted from a work area based on a first gesture;
acquiring a captured image of the determined conversion area;
generating a virtual image of the determined conversion area from the acquired captured image;
displaying the generated virtual image in the work area; and
performing a manipulation function with respect to the displayed virtual image based on a second gesture.

2. The method of claim 1, further comprising:
displaying an area guide in the work area; and
moving, zooming in, zooming out or rotating the displayed area guide based on the first gesture,
wherein the determining of the conversion area comprises determining a part of the work area corresponding to the area guide as the conversion area.

3. The method of claim 1, wherein the first gesture comprises an operation for designating a boundary showing the conversion area from the work area, and
wherein the generating of the virtual image comprises generating the virtual image of the part of the captured image corresponding to the designated boundary.

4. The method of claim 1, wherein the manipulation function comprises at least one of moving, changing, rotating and storing the virtual image.

5. The method of claim 1, wherein the performing of the manipulation function comprises:
designating a moving path of the conversion area based on the second gesture; and
moving the virtual image along the designated moving path.

6. The method of claim 1, further comprising displaying a second virtual image in a location of at least one marker on the work area corresponding to the marker.

7. The method of claim 6, further comprising moving and displaying the second virtual image according to the movement of the marker.

8. The method of claim 6, further comprising performing the manipulation function with respect to the second virtual image based on the second gesture.

9. The method of claim 6, wherein the displaying of the second virtual image comprises:
displaying a plurality of menu items; and
displaying a virtual image with an effect corresponding to a menu item selected based on a third gesture.

10. An augmented reality system comprising:
a camera configured to acquire a captured image of a work area;
a projector configured to project an image to the work area; and
a control device configured to determine a conversion area to be converted from the work area based on a first gesture, generate a virtual image of the determined conversion area based on a captured image acquired by the camera, display the generated virtual image in the work area using the projector, and perform a manipulation function with respect to the displayed virtual image based on a second gesture.

11. The augmented reality system of claim 10, wherein the control device displays an area guide in the work area using the projector, moves, zooms in, zooms out or rotates the displayed area guide based on the first gesture, and determines a part of the work area corresponding to the area guide, as the conversion area.

12. The augmented reality system of claim 10, wherein the first gesture comprises a gesture for designating a boundary showing the conversion area from the work area, and the control device generates the virtual image of a part of the captured image corresponding to the designated boundary.

13. The augmented reality system of claim 10, wherein the manipulation function comprises at least one of movement, change, rotation and storage of the virtual image.

14. The augmented reality system of claim 10, wherein the control device designates a moving path of the conversion area based on the second gesture and moves the virtual image along the designated moving path.

15. The augmented reality system of claim 10, wherein the control device displays a second virtual image in a location of at least one marker on the work area corresponding to the marker using the projector.

16. The augmented reality system of claim 15, wherein the control device moves and displays the second virtual image according to the movement of the marker.

17. The augmented reality system of claim 15, wherein the control device performs the manipulation function with respect to the second virtual image based on the second gesture.

18. The augmented reality system of claim 15, wherein the second virtual image includes a plurality of menu items, and the control device displays a virtual image with an effect corresponding to a menu item selected based on a third gesture.

19. A method of controlling an augmented reality system, the method comprising:
displaying a first virtual image in one of a work area and a part of a user's body located within the work area;
changing the virtual image into a second virtual image and displaying the second virtual image based on a first gesture; and
performing a manipulation function with respect to the displayed second virtual image based on a second gesture.

20. The method of claim 19, wherein the displaying of the first virtual image comprises displaying one of the first virtual image and the second virtual image in a size corresponding to the part of the user's body.

21. The method of claim 19, further comprising selecting the second virtual image as a virtual image to which the manipulation function is performed based on a third gesture.

22. The method of claim 21, further comprising displaying the selected second virtual image in a size corresponding to the work area.

23. The method of claim 19, wherein the changing of the virtual image and the displaying of the second virtual image comprises displaying the second virtual image as a next image after the displaying of the first virtual image selected from a plurality of stored virtual images.

24. The method of claim 19, wherein the manipulation function comprises at least one of movement, change, rotation and storage of the virtual image.

25. An augmented reality system comprising:
a camera configured to acquire a captured image of a work area;
a projector configured to project an image to the work area; and
a control device configured to display a first virtual image in one of the work area and a part of a user's body located within the work area using the projector, change the first virtual image into a second virtual image and displays the second virtual image based on a first gesture using the acquired captured image, and perform a manipulation function with respect to the displayed second virtual image based on a second gesture.

26. The augmented reality system of claim 25, wherein the control device displays one of the first virtual image and the second virtual image in a size corresponding to the part of the user's body.

27. The augmented reality system of claim 25, wherein the control device selects the second virtual image as a virtual image to which the manipulation function is performed based on a third gesture.

28. The augmented reality system of claim 27, wherein the control device displays the selected second virtual image in a size corresponding to the work area.

29. The augmented reality system of claim 25, wherein the control device displays the second virtual image as a next image after the displaying of the first virtual image selected from a plurality of stored virtual images.

30. The augmented reality system of claim 25, wherein the manipulation function comprises at least one of movement, change, rotation and storage of the virtual image.
